(19) United States
(12) Patent Application Publication
(10) Pub. No.: US 2026/0102938 A1
(43) Pub. Date: Apr. 16, 2026

(54) APPARATUS FOR NOTCHING AN ELECTRODE PLATE

(71) Applicant: SAMSUNG SDI CO., LTD., Yongin-si (KR)

(72) Inventor: Sangjin KIM, Yongin-si (KR)

(21) Appl. No.: 19/304,738

(22) Filed: Aug. 20, 2025

(30) Foreign Application Priority Data
Oct. 16, 2024 (KR) 10-2024-0141252

(51) Int. Cl. B26F 1/44; H01M 10/04

(52) U.S. Cl. CPC B26F 1/44; H01M 10/0431; B26F 2001/4436; B26F 2001/4481

(57) ABSTRACT

The present disclosure provides an apparatus for notching and a method for notching. The apparatus for notching includes at least one wire cutter that cuts at least one of a first side surface and a second side surface positioned opposite to the first side surface and at least one pattern cutter that cuts at least one of the first side surface and the second side surface to form a cut pattern, and the wire cutter is disposed to face the electrode plate along the first direction.

### CROSS-REFERENCE TO RELATED APPLICATION

This application claims priority under 35 U.S.C. §119 to Korean Patent Application No. 10-2024-0141252, filed in the Korean Intellectual Property Office on October 16, 2024, the entire contents of which are hereby incorporated by reference.

### BACKGROUND

### FIELD

The present disclosure relates to an apparatus for notching and a method for notching used in a process of manufacturing a secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An electrode assembly has a structure in which an electrode and an isolation film are alternately stacked. The electrode may be made by forming an electrode tab on an electrode plate, with the electrode tab being cut in a notching process to a small width fit for a cell standard. In general, the notching process may be performed by a method using a die and a method using a laser. In the process for notching using a die, a die is used repetitively, and, thus, abrasion may occur in the die, which may thereby cause problems with respect to the quality of the electrode plate. Moreover, in a case where the cell standard is changed, a new die may be needed to meet the new cell standard. On the other hand, a notching process using a laser has a problem in that it cannot be used for an electrode plate containing particular materials (for example, Fe and the like).

The above information disclosed in this Background section is for enhancement of understanding of the background of the present disclosure, and therefore, it may contain information that does not constitute related (or prior) art.

### SUMMARY

An apparatus for notching according to one or more example embodiments may be used to manufacture an electrode plate by a notching process that does not include the use of a die or a laser.

A method of notching according to one or more example embodiments may manufacture an electrode plate using by notching but not using a die or a laser.

These and other aspects and features of the present disclosure will be described in or will be apparent from the following description of embodiments of the present disclosure.

An apparatus for notching according to one or more embodiments of the present disclosure includes at least one wire cutter that is configured to cut at least one of a first side surface of an electrode plate and a second side surface of the electrode plate that is positioned opposite to the first side surface, with the cutting being along a direction in which the electrode plate moves in the apparatus, and at least one pattern cutter that is configured to cut at least one of the first side surface and the second side surface to form a cut pattern in the electrode plate, and the wire cutter is positioned to face the electrode plate along the direction in which the electrode plate moves.

According to one or more embodiments, a cutting edge of the wire cutter may be positioned to extend in a thickness direction of the electrode plate.

According to one or more embodiments, the wire cutter may include a first wire cutter that is configured to cut the first side surface and a second wire cutter that is spaced from the first wire cutter and is configured to cut the second side surface, and the distance between the first wire cutter and the second wire cutter may be adjustable.

According to one or more embodiments, the wire cutter may be configured to cut at least a part of an uncoated portion of the electrode plate from at least one of the first side surface and the second side surface, and the pattern cutter may be configured to cut at least one of the uncoated portion of the electrode plate disposed on at least one of the first side surface and the second side surface and a mixture portion that is between the uncoated portion.

According to one or more embodiments, the wire cutter may be disposed to be fixed while the electrode is moving.

According to one or more embodiments, each of the wire cutter and the pattern cutter may include at least one of metal, carbon steel, stainless steel, ceramic, and diamond.

According to one or more embodiments, the pattern cutter may be configured move at a same speed as the electrode plate in the direction that the electrode plate moves.

According to one or more embodiments, the pattern cutter may include a first pattern cutting element that is configured to cut the electrode plate in a second direction and a second pattern cutting element that is configured to cut the electrode plate in the first direction or a third direction.

According to one or more embodiments, the first pattern cutting element may be configured to face a side surface of the electrode plate along the second direction, and the second direction may intersect a thickness direction of the electrode plate.

According to one or more embodiments, a cross-sectional shape of the wire cutter may be (i) triangular, (ii) a shape in which one side of a triangle is replaced with a curve, or (iii) a polygon shape with an acute angle, and one side of the wire cutter may be parallel to the first direction.

According to one or more embodiments, the pattern cutter may include a plurality of saw teeth that are triangular or a shape in which one side of a triangle is replaced with a curve.

According to one or more embodiments, the pattern cutter may include a first pattern cutter and a second pattern cutter, and the second pattern cutter may form a second cut pattern by cutting a first cut pattern formed by the first pattern cutter.

According to one or more embodiments, a cross-section shape of the pattern cutter may be an isosceles triangle or a right triangle.

A secondary battery according to one or more embodiments of the present disclosure includes at least one wire cutter that is configured to cut a first side surface of an electrode plate and a second side surface of the electrode plate that is opposite to the first side surface, with the cutting being along a first direction in which the electrode plate moves in the apparatus and at least one pattern cutter that is configured to cut at least one of the first side surface and the second side surface to form a cut pattern, the wire cutter is positioned to face the electrode plate along the first direction, a cutting edge of the wire cutter is configured to extend in a thickness direction of the electrode plate, the wire cutter includes a first wire cutter that is configured to cut the first side surface and a second wire cutter that is spaced a distance from the first wire cutter and cuts the second side surface, the distance between the first wire cutter and the second wire cutter is adjustable, and the pattern cutter includes a first pattern cutting element that cuts the electrode plate along a second direction and a second pattern cutting element that cuts the electrode plate along the first direction or a third direction that is different from the second direction.

A method for notching according to one or more embodiments of the present invention to resolve the above technical tasks includes a first step of cutting an uncoated portion disposed on at least one of a first side surface of an electrode plate and a second side surface of the electrode plate that is positioned opposite to the first side surface, the cutting being along a direction that the electrode plate moves, the cutting being performed by using at least one wire cutter, and a second step of removing at least one of the uncoated portion disposed on one of the first side surface and the second side surface and a mixture portion, the removing being performed by using at least one pattern cutter to thereby form a cut pattern.

According to one or more embodiments, the wire cutter may be fixed to face the electrode plate along the first direction.

According to one or more embodiments, a cutting edge of the wire cutter may extend in a thickness direction of the electrode plate, the wire cutter may include a first wire cutter that cuts the first side surface and a second wire cutter that is spaced at a distance from the first wire cutter and cuts the second side surface, and a distance between the first wire cutter and the second wire cutter may be adjustable.

According to one or more embodiments, the method for notching may further include, before the first step, a step of adjusting the distance between the first wire cutter and the second wire cutter based a width of the electrode plate that intersects the first direction.

According to one or more embodiments, the first step may further include a step of adjusting a distance between the first wire cutter and the second wire cutter based on the width of the electrode plate that intersects the first direction.

According to one or more embodiments, the pattern cutter may include a first pattern cutting element that cuts the electrode plate along the second direction and a second pattern cutting element that cuts the electrode plate along the first direction or a third direction that is different from the second direction.

According to one or more embodiments, the method for notching may further include, before the first step, a step of adjusting a length by which the pattern cutter performs the cutting such that at least one of a shape or an interval of the cut pattern is adjusted.

The apparatus for notching according to one or more example embodiments performs notching on the electrode plate without a die,. Thus, it is possible to prevent a process error that may occur due to abrasion of a die.

The apparatus for notching according to one or more example embodiments performs notching on the electrode plate without a die. Thus, it is possible to adjust a manufacturing to a new electrode standard without providing a new die.

The method for notching according to one or more example embodiments performs notching on the electrode plate without using a die. Thus it is possible to reduce errors of the electrode plate manufacturing process and to maintain the quality of the electrode plate.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a view of an electrode plate manufacturing apparatus used in a process of manufacturing a secondary battery according to one or more example embodiments.

FIG. 2a is a perspective view of an apparatus for notching according to one or more example embodiments.

FIG. 2b is a perspective view of an apparatus for notching according to other example embodiments.

FIG. 3a is a plan view of notching an electrode plate having one width by an apparatus for notching according to one or more example embodiments.

FIG. 3b is a plan view of notching an electrode plate having the other one width by an apparatus for notching according to one or more example embodiments.

FIG. 3c is a plan view of fixing a part of an uncoated portion cut in a process of notching an electrode plate by an apparatus for notching according to one or more example embodiments.

FIG. 4a is a plan view an electrode plate notched by an apparatus for notching according to one or more example embodiments.

FIG. 4b is a plan view of an electrode plate notched by an apparatus for notching according to one or more example embodiments.

FIGS. 5a to 5g are views of a wire cutter included in an apparatus for notching according to one or more example embodiments.

FIGS. 6a to 6d are views of a pattern cutter included in an apparatus for notching according to one or more embodiments.

FIG. 7a is a view of an apparatus for notching according to one or more embodiments.

FIG. 7b is a view of an apparatus for notching according to other example embodiments.

FIG. 8 is a plan view of notching an electrode plate by an apparatus for notching including a plurality of pattern cutters according to one or more example embodiments.

FIG. 9 is a perspective view of an apparatus for notching according to another example embodiment.

FIG. 10 is a plan view of notching an electrode plate by an apparatus for notching according to another example embodiment.

FIG. 11 is a flow chart of a method for notching according to one or more example embodiments.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

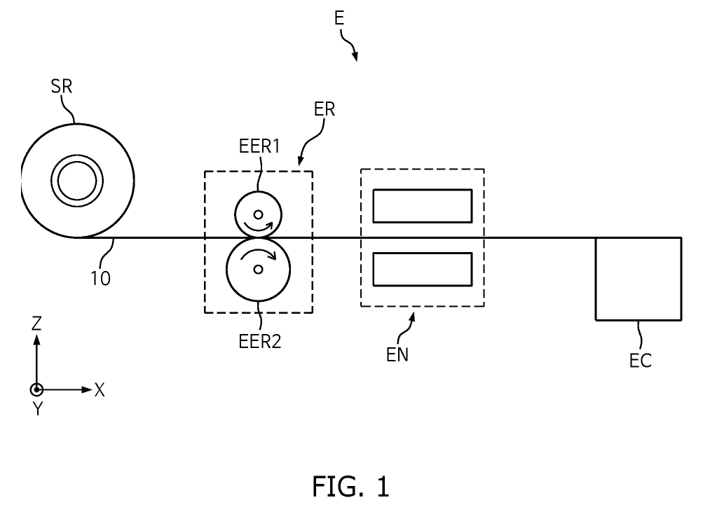

FIG. 1 is a view of an electrode plate manufacturing apparatus for a secondary battery according to one or more example embodiments.

Referring to FIG. 1, an electrode plate manufacturing apparatus (E) may include a supply roll (SR) that supplies an electrode plate (10), a rolling portion (ER), a notching portion (EN), and a collection portion (EC). The electrode plate (10) supplied by the supply roll (SR) may be a substrate on which an active material layer has been already coated. The active material layer in the electrode plate (10) may be coated on one or both surfaces of the substrate. The rolling portion (ER) rolls the active material layer coated on the substrate of the electrode plate (10) by passing the electrode plate (10) between two rollers (ERR1, ERR2) and thereby can make a thickness and a surface of the electrode plate (10) uniform and flat.

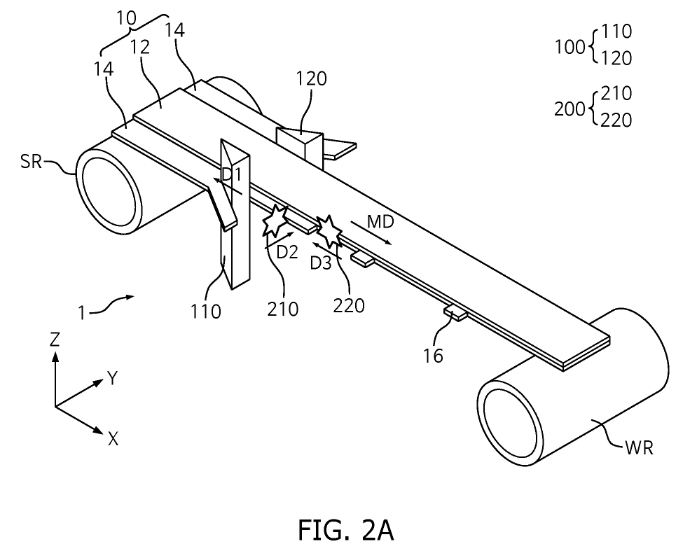

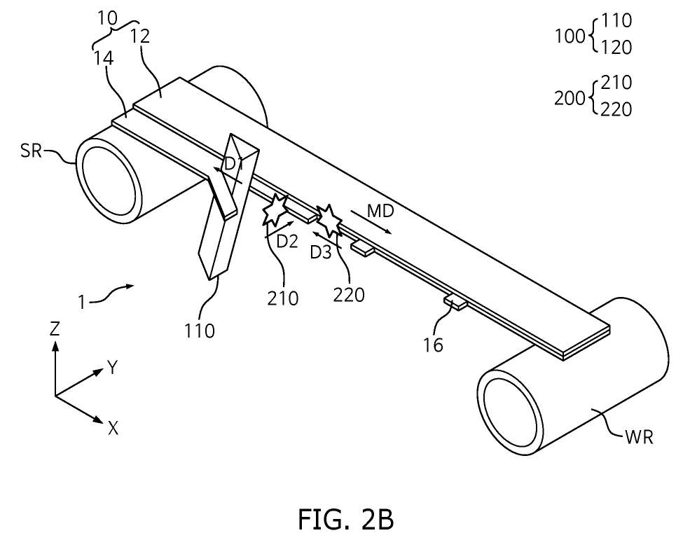

The electrode plate (10) that has passed through the rolling portion (ER) may be notched in the notching portion (EN). For example, the notching portion (EN) may form a tab portion by cutting or punching an uncoated portion on which the active material layer is not coated on the electrode plate (10). For this, the notching portion (EN) may include a wire cutter that cuts at least one of the side surfaces of the electrode plate (10) along a direction in which the electrode plate (10) moves in the manufacturing apparatus (E). The notching portion (EN) may include a pattern cutter that cuts at least one of the side surfaces of the electrode plate (10) to form a cut pattern corresponding to the tab portion. A detailed configuration of the apparatus for notching corresponding to the notching portion (EN) will be described below with reference to FIGS. 2a to 10.

The collection portion (EC) may store or accommodate the electrode plate (10) notched by the notching portion (EN). The collection portion (EC) may include various elements such as a winding roll (WR) or a magazine depending on the type of the secondary battery.

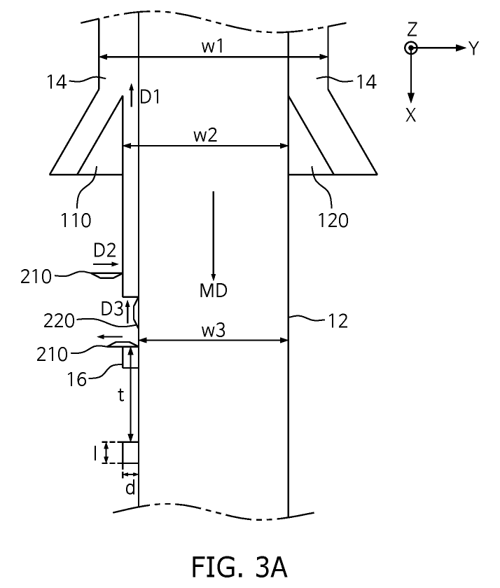

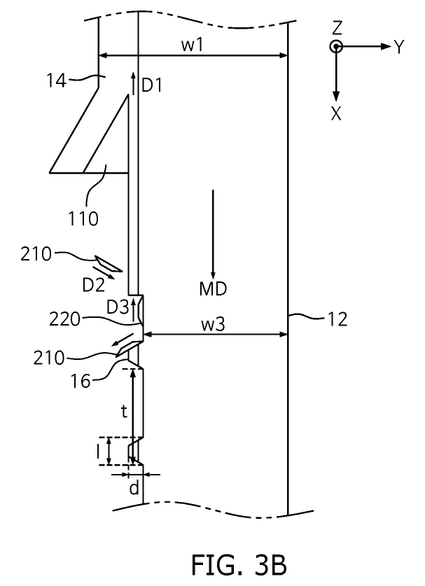

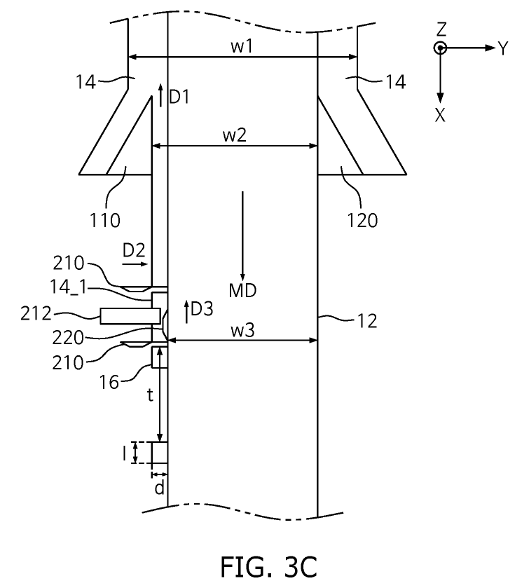

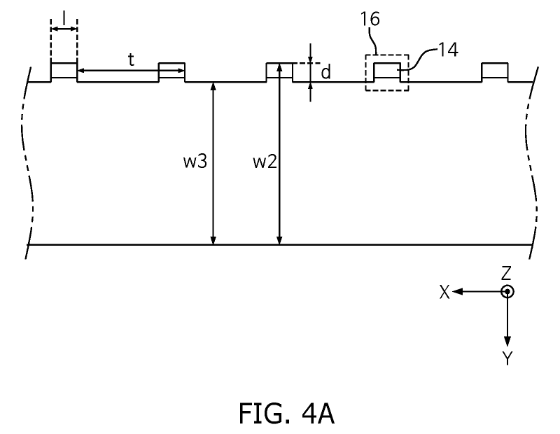

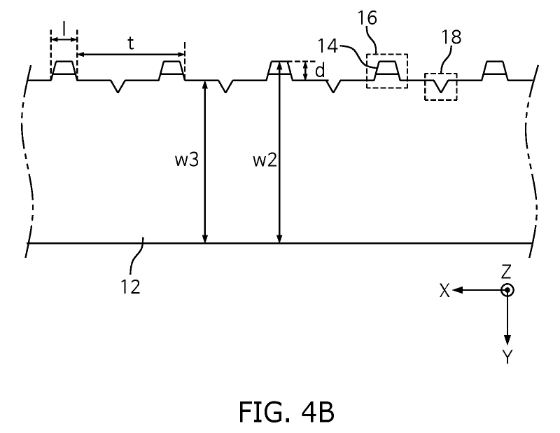

FIG. 2a is a perspective view of an apparatus for notching according to one or more example embodiments, and FIG. 2b is a perspective view an apparatus for notching according to other example embodiments. FIG. 3a is a plan view of use of notching an electrode plate having one width by an apparatus for notching according to one or more example embodiments, and FIG. 3b is a plan view of use of notching an electrode plate having the other one width by an apparatus for notching according to one or more example embodiments. FIG. 3c is a plan view of fixing a part of an uncoated portion cut in a process of notching an electrode plate by an apparatus for notching according to one or more example embodiments. FIG. 4a is a plan view of an electrode plate notched by an apparatus for notching according to one or more example embodiments, and FIG. 4b is a plan view of an electrode plate notched by an apparatus for notching according to one or more example embodiments.

Referring to FIGS. 2a and 2b, an apparatus for notching (1) according to one or more example embodiments may include at least one wire cutter (100) that cuts at least one of a first side surface and a second side surface, positioned opposite to the first side surface, of the electrode plate (10). The wire cutter (100) cuts the electrode plate (10) along a first direction and at least one pattern cutter (200) cuts at least one of the first side surface and the second side surface to form a cut pattern. Here, the first direction may be a direction (MD) that the electrode plate (10) moves in the notching apparatus (1), and the wire cutter (100) may be disposed to face the electrode plate (10) along the first direction.

The electrode plate (10) may be supplied from the supply roll (SR), formed or processed by the wire cutter (100) and/or the pattern cutter (200), and then wound by the winding roll (WR) or stacked by the magazine. The apparatus for notching (1) may form tab portions (16) that function as electrode tabs or are connected with a separate electrode tab by notching the electrode plate (10) that proceeds in the first direction using the wire cutter (100) and the pattern cutter (200). The electrode plate (10) may include a mixture portion (12) including an active material and an uncoated portion (14) not including an active material. The mixture portion (12) may include a positive electrode active material or a negative electrode active material depending on the type of the electrode plate (10). A region in which a mixture including an active material is coated on the substrate may be the mixture portion (12) of the electrode plate (10), and a portion other than the region on which the mixture portion (12) is coated on the substrate may be the uncoated portion (14) of the electrode plate (10). In a plan view, both side ends in a direction intersecting the movement direction (MD) of the electrode plate (10) may be the uncoated portions (14), and the mixture portion (12) may be positioned between the uncoated portions (14). That is, the uncoated portions (14) may be positioned on both side surfaces of the electrode plate (10).

A process of notching the electrode plate (10) by the apparatus for notching (1) to form the tab portions (16) may be performed as the electrode plate (10) moves in the first direction. The movement direction (MD) of the electrode plate (10) may be substantially parallel to or the same as the first direction. In the example depicted in FIGS. 2a and 2b, the first direction may be an X axis direction.

The apparatus for notching (1) according to one or more embodiments may include the wire cutter (100). The wire cutter (100) may cut the uncoated portion (14) from at least one of the first side surface and the second side surface, which are positioned opposite to each other, based on the movement direction (MD) of the electrode plate (10) or the first direction in the apparatus for notching (1). As cutting is performed while the electrode plate (10) is moving in the first direction, a direction (D1) in which the wire cutter (100) cuts the uncoated portion (14) may be opposite to the first direction. The cutting direction (D1) may be direction that the wire cutter (100) moves relative to the electrode plate (10) at a speed that the electrode plate (10) and wire cutter (100) are moving relative to each other.

The wire cutter (100) may be disposed to face the electrode plate (10) along the first direction. This means that as the electrode plate (10) moves in the first direction before the electrode plate (10) is cut by the wire cutter (100), a distance of the electrode plate (10) facing the wire cutter (100) is decreased until the electrode plate (10) is in contact with the wire cutter (100). The wire cutter (100) may be a movable type or a fixed type. For example, when the electrode plate (10) does not move while being maintained under a tension between rollers (SR, WR), a movable type wire cutter (100) may be used. In a case where the wire cutter (100) is a movable type, the wire cutter (100) may have a speed component in the cutting direction (D1). On the other hand, in a case where the electrode plate (10) moves in a direction (or first direction), a fixed type wire cutter (100) or a movable type wire cutter (100) may be used.

A cross-section cut by the wire cutter (100) may be a plane extending in the first direction and a thickness direction of the electrode plate (10). The first direction may be an X axis direction and the thickness direction of the electrode plate (10) may be a Z axis direction. The first side surface cut by a first wire cutter (110) may be substantially flat, and the second side surface cut by a second wire cutter (120) may be substantially flat.

A cutting edge of the wire cutter (100) may be a portion that contacts the electrode plate (10) to be cut. That is, a portion of the wire cutter (100) that contacts the electrode plate (10) when the wire cutter (100) cuts the electrode plate (10) may be referred to as a cutting edge of the wire cutter (100). The electrode plate (10) contacting the cutting edge of the wire cutter (100) may be cut, and a width of the electrode plate (10) is thereby narrowed. The width of the supplied electrode plate (10) means a width of the electrode plate (10) intersecting the first direction or a width (w1) of the electrode plate (10) perpendicular to the first direction. For example, in a case where the first direction is an X axis direction, the width of the electrode plate (10) means the width (w1) of the electrode plate (10) as a second direction intersecting the first direction.

Referring to FIG. 2a, the cutting edge of the wire cutter (100) may be, for example, extend in the thickness direction (for example, Z direction) of the electrode plate (10). This may mean that a line connecting two points on the cutting edge of the wire cutter (100) is substantially parallel to the thickness direction of the electrode plate (10). However, the present disclosure is not limited to such an arrangement, and the cutting edge of the wire cutter (100) may be, for example, positioned to extend in a direction including a first direction component and the thickness direction component, e.g., diagonal to the first direction.

Referring to FIG. 2b, the cutting edge of the wire cutter (100) may extend in a direction including an X direction component and a Z direction component. Further, the cutting edge of the wire cutter (100) may extend in a Y direction such that a width of the electrode plate (10) is gradually decreased along a thickness direction. However, in order for the electrode plate (10) to meet the cutting edge of the wire cutter (100) to be cut as the electrode plate (10) moves along the movement direction (MD), the cutting edge of the wire cutter (100) should include the first direction component, and, thus, the cutting edge of the wire cutter (100) extends in the first direction. The cutting edge of the wire cutter (100) of the apparatus for notching (1) extends along a straight line. But the present disclosure is not limited thereto, and the cutting edge of the wire cutter (100) be curved.

The wire cutter (100) may be formed from a material that includes at least one of metal, carbon steel, stainless steel, ceramic, and diamond. For example, the metal may be steel, titanium, or the like. However, the material of the wire cutter (100) is not limited to these examples and may include other materials that can cut the electrode plate (100). For example, the wire cutter (100) may be formed from a material that is harder than the material from which the electrode plate (10) is formed.

The cross-sectional shape of the wire cutter (100) may be triangular or a shape in which one side of a triangle is replaced with a curve. The cross-sectional shape may correspond to the shape of the wire cutter as seen from above the wire cutter. Moreover, the one side of the cross-sectional shape may be substantially parallel to the first direction. With such an arrangement, the the electrode plate (10) may be cut to a substantially uniform width. The other side of the cross-sectional shape that includes the cutting edge of the wire cutter (100) may form a predetermined angle such that the cut electrode plate (10) is easily released from the wire cutter. Detailed descriptions of the shape of the wire cutter (100) will be provided below.

The wire cutter (100) may include the first wire cutter (110) and the second wire cutter (120). The first and second wire cutters (110, 120) may cut a first side surface and a second side surface of the electrode plate (10), respectively. For example, the first wire cutter (110) may cut the first side surface of the electrode plate (10), and at this time, may cut at least a part of the uncoated portion (14) of the first side surface. Moreover, although not illustrated, the first wire cutter (110) may cut the entirety of the uncoated portion (14) of the first side surface and a part of the mixture portion (12) that is adjacent to the uncoated portion (14). The second wire cutter (120) may cut the second side surface of the electrode plate (10), and, at this time, may cut at least a part of the uncoated portion (14) of the second side surface. In other examples, the second wire cutter (120) may cut the entirety of the uncoated portion (14) of the second side surface and a part of the mixture portion (12) adjacent to the uncoated portion (14). Therefore, on the first side surface, only the uncoated portion (14) may be disposed, and on the second side surface, the mixture portion (12) may be exposed. However, the present disclosure is not limited to such an arrangement. For example, in a case where only one wire cutter (100) is provided, the wire cutter (100) may cut the first side surface of the electrode plate (10). In another example, one wire cutter (100) may be disposed on the second side surface to cut the electrode plate (10) on which the mixture portion (12) is disposed.

Referring to FIG. 3a, the first wire cutter (110) and the second wire cutter (120) are spaced from each other. A distance (w2) between the first wire cutter (110) and the second wire cutter (120) is a straight-line distance between a position where the electrode plate (10) is cut by the first wire cutter (110) and a position where the electrode plate (10) is cut by the second wire cutter (120). The straight line may be a line parallel to the second direction (for example, Y axis direction) perpendicular to the thickness direction of the electrode plate (10). The distance (w2) may be less than the width (w1) before the electrode plate (10) passes through the wire cutter (100), that is, the width (w1) before the electrode plate (10) is cut. The electrode plate (10) may be cut to a width corresponding to the distance (w2) after passing through the wire cutter (100). However, the present disclosure is not limited thereto, and when there is only one wire cutter (100), only the first side surface of the electrode plate (10) may be cut, and the electrode plate (10) may be cut into a straight-line distance between the first wire cutter (110) and the second side surface. In such an example, the mixture portion (12) may be exposed on the second side surface and the uncoated portion (14) is not provided on the second side surface, and, thus, the second side surface may not be cut by the wire cutter (100).

The first wire cutter (110) and the second wire cutter (120) may be connected by a horizontal bar. The horizontal bar may be positioned to not hinder movement of the electrode plate (10). Therefore, even when the horizontal bar is provided, the position where the electrode plate (10) is cut by the first wire cutter (110) and the position where the electrode plate (10) is cut by the second wire cutter (120) may be spaced from each other.

Referring to FIG. 3a, the distance (w2) between the first wire cutter (110) and the second wire cutter (120) may be adjusted as needed. In this regard, at least one of the wire cutters (100) may move in the second direction. The second direction may be perpendicular to the first direction, which is the movement direction (MD) in which the electrode plate (10) moves, and the thickness direction (Z direction in FIG. 3a) of the electrode plate (10). When the first direction and the thickness direction correspond to the X axis direction and the Z axis direction, respectively, the second direction may correspond to the Y axis direction. The first wire cutter (110) may be fixed, the second wire cutter (120) may be movable or vice versa. Moreover, both of the first wire cutter (110) and the second wire cutter (120) may be movable. Therefore, the distance (w2) may be adjusted, and as a result, a width (w3) of the electrode plate (10) may be adjusted as needed. The width (w3) of the electrode plate (10) may correspond to a width of the mixture portion in a plan view.

The distance (w2) between the first wire cutter (110) and the second wire cutter (120) may be adjusted or set in advance before the electrode plate (10) is supplied by the supply roll (SR). When the width (w1) of the electrode plate (10) supplied by the supply roll (SR) is changed, the distance (w2) may be adjusted to be changed. However, the present disclosure is not limited thereto, and the distance (w2) may be adjusted in real time during the process of notching the electrode plate.

Unlike the apparatus for notching using a die, in the apparatus for notching (1) according to one or more example embodiments, the distance (w2) between the first wire cutter (110) and the second wire cutter (120) may be adjusted. Thus, even if a size of the electrode plate (10) to be notched or a cell including thereof is changed, it may not be necessary to use a different die. That is, the apparatus for notching (1) according to one or more example embodiments may adjust a position of the wire cutter (100) in accordance with the width (w3) of the electrode plate (10) to be notched or the size of the cell including thereof. Therefore, the apparatus for notching (1) having the configuration described above can solve problems in management of a dies and die quality which may be caused, for example, by abrasion of the die.

The apparatus for notching (1) according to one or more example embodiments may include at least one pattern cutter (200) that cuts at least one of the first side surface and the second side surface of the electrode plate (10) to form a cut pattern. A surface of the electrode plate (10) that is cut by the pattern cutter (200 a surface on which the uncoated portion (14) is exposed. The pattern cutter (200) may cut the uncoated portion (14) and/or the mixture portion (12) adjacent to the uncoated portion to form a plurality of cut patterns, and the cut pattern may correspond to the tab portions (16).

The cut pattern on a surface of the electrode plate (10) may form protrusions in the second direction (for example, Y axis direction). A portion excluding cutting may be removed to form a pattern. For this, the cutting direction of the pattern cutter (200) may be the first direction, which is the movement direction of the electrode plate (10), and the second direction that is perpendicular to the movement direction of the electrode plate (10) and perpendicular to the thickness direction of the electrode plate (10). For example, the first direction and the second direction, which are cutting directions of the pattern cutter (200), may be an X axis direction and a Y axis direction, respectively.

The pattern cutter (200) may include a first pattern cutting element (210) and a second pattern cutting element (220). The first pattern cutting element (210) may be disposed to face a side surface of the electrode plate (10) along the second direction. This means that as the first pattern cutting element (210) moves toward the electrode plate (10) in the second direction before the electrode plate (10) is cut by the first pattern cutting element (210), a distance of the first pattern cutting element (210) facing the electrode plate (10) decreases, and the first pattern cutting element (210) moves into contact with the electrode plate (10). The second pattern cutting element (220) may be disposed to face the electrode plate (10) along the thickness direction. This means that as the second pattern cutting element (220) moves toward the electrode plate (10) in the thickness direction before the electrode plate (10) is cut by the second pattern cutting element (220), a distance of the second pattern cutting element (220) facing the electrode plate (10) is decreases and the second pattern cutting element (220) moves into contact with the electrode plate (10).

A cross-section cut by the first pattern cutting element (210) may be substantially flat. For example, the cross-section may be a plane including the second direction and the thickness direction of the electrode plate (10). A cross-section cut by the second pattern cutting element (220) may be substantially flat. For example, the cross-section may be a plane including the first direction and the thickness direction of the electrode plate (10). At this time, the first direction may be a X axis direction, the second direction may be a Y axis direction, and the thickness direction of the electrode plate (10) may be a Z axis direction.

A cross-section of the pattern cutter (200) may be in a circular saw shape. The pattern cutter (200) may include a plurality of saw teeth that are triangluar shaped or a shape in which one side of a triangle is replaced with a curve. However, the present disclosure is not limited to such configurations, and the pattern cutter (200) may have saw teeth in other shapes that can cut the electrode plate (10). A detailed description of the plane shape of the pattern cutter (200) will be provided below.

The cutting edge of the pattern cutter (200) may be a portion where the electrode plate (10) contacts the pattern cutter (200). That is, a portion of the pattern cutter (200) that contacts the electrode plate (10) when the pattern cutter (200) cuts the electrode plate (10) may be the cutting edge of the pattern cutter (200). The electrode plate (10) that contacts the cutting edge of the pattern cutter (200) is cut, and thereby, a cut pattern may be formed.

The pattern cutter (200) may be formed from materials such as metal, carbon steel, stainless steel, ceramic, and diamond. For example, the metal may be steel, titanium, or the like. However, the material of the pattern cutter (200) is not limited to these examples, and other materials that can cut the electrode plate (10) may be used. For example, the pattern cutter (200) may include a material that is harder than the electrode plate (10).

The first pattern cutting element (210) may cut the electrode plate (10) in the second direction, and the second pattern cutting element (220) may cut the electrode plate in the first direction or the third direction, which are different from the second direction. The first direction may correspond to a direction (MD) in which the electrode plate (10) moves. And the second direction may be a direction intersecting a thickness direction of the electrode plate (10) or may be a direction perpendicular to the thickness direction of the electrode plate (10). In a case of the latter, the first direction, the second direction, and the thickness direction of the electrode plate (10) may correspond to the X axis direction, the Y axis direction, and the Z axis direction, respectively. The third direction may intersect the first direction and the second direction or may be a direction perpendicular to the first direction and the second direction. In a case of the latter, the first direction, the second direction, and the third direction may correspond to the X axis direction, the Y axis direction, and the Z axis direction. The third direction may correspond to the thickness direction of the electrode plate (10).

In an example, the first pattern cutting element (210) may cut the electrode plate (10) in the Y axis direction. That is, a cutting direction (D2) of the first pattern cutting element (210) may be the Y axis direction as shown in FIGS. 3a and 3b. The cutting direction (D2) may be relative to a movement direction the electrode plate (10) and relative to a speed of the electrode plate (10). A depth (d) of the cut that forms the tab portion (16) corresponds to the cut made by the first pattern cutting element (210). The second pattern cutting element (220) may cut the electrode plate (10) in the Z axis direction. That is, a cutting direction (D3) of the second pattern cutting element (220) may be the Z axis direction. A length of the tab portion (16) is determined by the second pattern cutting element (220), and a distance (t) between the tab portions (16) may be formed. A plane of the tab portion (16) formed by the first pattern cutting element (210) and the second pattern cutting element (220) may be rectangular. However, the present disclosure is not limited thereto. For example, the cutting direction (D2) of the first pattern cutting element (210) may be in a plane including the X axis and the Y axis, and the tab portion (16) may thereby be formed in a parallelogram or trapezoidal shape. Various other shapes are possible by adjusting the cutting direction (D2).

The second pattern cutting element (220) may cut the electrode plate (10) in the thickness direction while initially cutting the electrode plate (10). During this cut, a speed of the second pattern cutting element (220) in the first direction and a speed of the electrode plate (10) in the first direction may be substantially the same as each other. Thereafter, the second pattern cutting element (220) may substantially move at a speed in the first direction at the speed of the electrode plate (10). In an example, while the second pattern cutting element (220) cuts the electrode plate (10), the second pattern cutting element (220) may be fixed at a predetermined position for a static system (inertial system based on ground), and the electrode plate (10) may continuously move at a first speed in the first direction. In some cases, the electrode plate (10) may be cut by a distance that the electrode plate (10) moves. In another example, when cutting the electrode plate (10), the second pattern cutting element (220) may move at a second speed different from the first speed of the electrode plate (10) in the first direction with respect to a static system. The second speed may be greater than the first speed, or may be less than the first speed. The relative direction of movement may be positive or negative. Here, a negative relative direction of movement means that the second pattern cutting element (220) and the electrode plate (10) may move in opposite directions from each other in the static system. As such, the electrode plate (10) may be cut at a relative speed of the electrode plate (10) and the second pattern cutting element (220). And the cutting direction (D3) may be the first direction. Therefore, a distance (t) between the tab portions (16) may increase by the operation of the second pattern cutting element (220).

A length (l) of the tab portion (16) may also be adjusted by adjusting the operation of the second pattern cutting element (220). That is, the length of the cut to the electrode plate (10) by the pattern cutter 200 may be adjusted as necessary. For example, a translational movement distance of the first pattern cutting element (210), of which cutting distance (D2) is the Y axis direction, in the Y axis direction may be increased such that the depth (d) of the tab portion (16) is deep. In another case, a translational movement direction of the first pattern cutting element (210) in the Y axis direction may be decreased such that the depth (d) of the tab portion (16) is shallow. In another example, a translational movement distance of the second pattern cutting element (220) in the Z direction of the electrode plate (10) may be increased such that the distance (t) between the tab portions (16) is greater. This means that as the length by which the cutting edge of the second pattern cutting element (220) contacts the electrode plate (10) is increased, the distance (t) between the tab portions (16) is increased. In another case, the translational movement distance of the second pattern cutting element (220) in the Z axis direction may be decreased such that the the tab portions (16) are formed closely to each other.

The pattern cutter (200) may be moved in the first direction at substantially the same speed as the electrode plate (10) moves in the first direction. In this case, as a relative speed of the pattern cutter (200) and the electrode plate (10) in the first direction is close to 0, in the inertial system of moving at the speed the pattern cutter (200) may appear to cut the fixed electrode plate (10). After the electrode plate (10) is cut by the pattern cutter (200), the pattern cutter (200) may move in a direction opposite to the cutting direction and return to its original position. When the pattern cutter (200) returns to the original position, the relative speed of the pattern cutter (200) and the electrode plate (10) in the first direction may not be 0.

The pattern cutter (200) of the apparatus for notching (1) according to one or more example embodiments may include a third pattern cutter. The third pattern cutter may cut the mixture portion (12) of the electrode plate (10) to form a groove portion (18). The groove portion (18) may be in a pattern.

As described above, the length (l), the depth (d), and the interval (t) of the tab portions (16) may be adjusted through the first pattern cutting element (210) and the second pattern cutting element (220), and the shapes of the tab portions (16) also may be adjusted. Unlike a notching that uses a die, in the apparatus for notching (1) according to one or more example embodiments, even if the shape, the lengths (l), the depths (d), or the intervals (t) of the electrode tabs of the electrode plate (10) are changed, it may not be necessary to manufacture a separate die. That is, the apparatus for notching (1) according to one or more example embodiments can be adjusted to accommodate different sizes of the electrode plate (10) and shapes of the tab portions (16). Moreover, the apparatus for notching (1) according to one or more example embodiments can resolve problems in management of a die abrasion to the die.

Referring to FIG. 3c, as the first pattern cutting element (210) moves in the second direction (D2), when cutting the uncoated portion (14) (and/or part of mixture portion (12)), a cut portion (14_1) of the uncoated portion (14) may not have an enough tension required for the subsequent cutting process. As such, in some cases when the second pattern cutting element (220) moves in the thickness direction of the electrode plate (10) and cuts the portion (14_1), there may be a problem in that the portion (14_1) or the uncoated portion (14) around the portion (14_1) is curled or folded. In order to prevent such a problem, a device (212) such as a gripper can be provided to maintain a tension by fixing outer side terminal of the portion (14_1) that is formed by two first pattern cutting elements (210).

Referring to FIG. 4a, a cut pattern in which tab portions (16) are cyclically formed on a surface of the electrode plate (10) may be checked in a plane of the electrode plate (10). Each of the tab portions (16) may include an uncoated portion (14) where an active material is not provided. Each of the tab portions (16) may be used as an electrode tab or connected to an electrode tab. The mixture portion (12) may be exposed as a trench between the tab portions (16). Referring to FIG. 4b, a pattern in which tab portions (16) having different shapes from the tab portions (16) of FIG. 4a are formed in another cycle may be checked in a plane of the electrode plate (10). Furthermore, a groove portion (18) may be formed on the first side surface and/or the second side surface of the electrode plate (10).

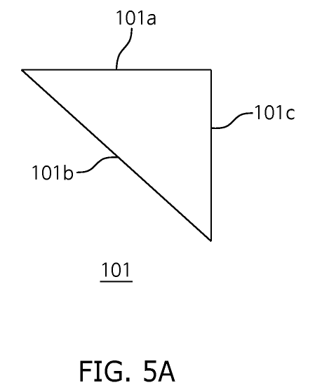

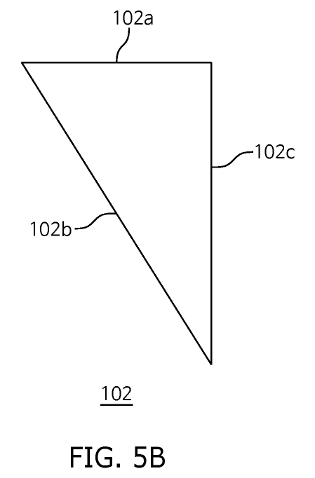

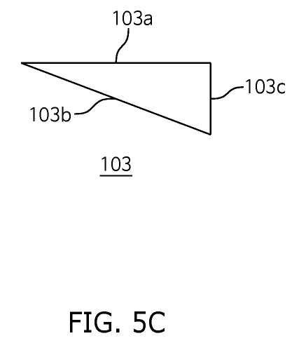

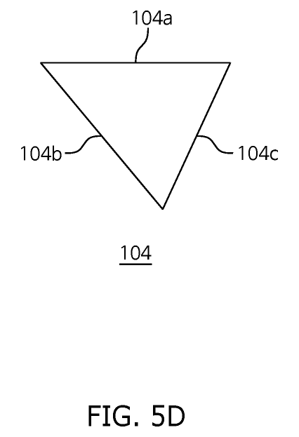

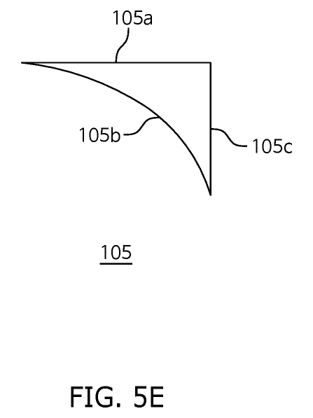

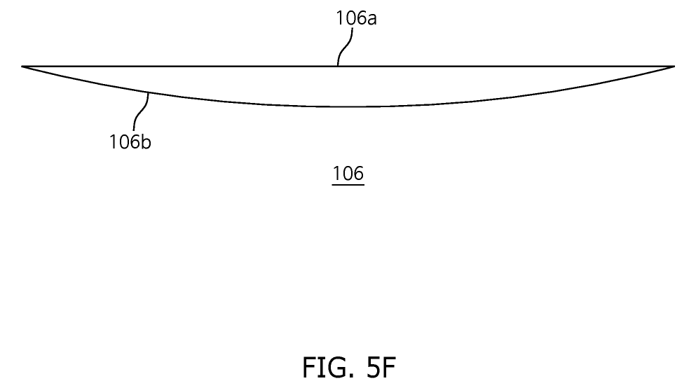

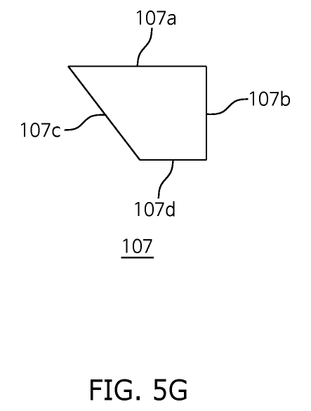

FIGS. 5a to 5g are views of cross-sectional (planar) shapes of wire cutters included in an apparatus for notching according to one or more example embodiments.

As illustrated, the cross-sectional shape of the wire cutter (100) may be a triangle shape or a shape in which one side of a triangle is replaced with a curve. Referring to FIGS. 5a to 5c, for example, the cross-sectional shape of the wire cutter (100) may be a right-angled triangle. Two sides (101a, 101c) (102a, 102c) (103a, 103c) forming a right angle may be sides substantially parallel to the first direction and the second direction and perpendicular to each other. Two sides (101a, 101c) (102a, 102c) (103a, 103c) forming a cutting edge may form an appropriate angle such that errors of the electrode plate manufacturing process are reduced, and such that the electrode plate (10) that is cut is removed and separated from the wire cutter (100).

Referring to FIG. 5d, the cross-sectional shape of the wire cutter (100) may be a general triangle and not a right-angled triangle. One (104a) of the three sides (104a, 104b, 104c) of the triangle may be substantially parallel to the first direction.

Referring to FIGS. 5e and 5f, the cross-sectional shape of the wire cutter (100) may be a shape in which one or two of the sides of a triangle is replaced with one or two curves. In such cases, one (105a) (106a) of sides that are not replaced (105a, 105b) (106a) may be substantially parallel to the first direction. The replaced sides (105b) (106b) may be curves that are convex upward or may be curves that are convex downward. The curve of the replaced side (105b) (106b) may be configured such that errors of the electrode plate manufacturing process may be reduced and such that the electrode plate (10) that is cut is removed and separated from the wire cutter (100).

Referring to FIG. 5g, the cross-sectional shape of the wire cutter (100) may be a quadrangle with an acute angle. One (107a) of the four sides (107a, 107b, 107c, 107d) may be substantially parallel to the first direction, and the acute angle may be selected based on necessity. The planar (cross-sectional) shape of the wire cutter (100) may be a polygon with an acute angle other than a quadrangle. The shapes of the wire cutter (100) described above for cutting a first surface of the electrode plate (10) may be symmetric with respect to the first direction (X axis direction) as a wire cutter (100) used to cut a second surface of the electrode plate (10).

The shapes of the wire cutters (100) in FIGS. 5a to 5g are examples. Wire cutters (100) according to embodiments of the present disclosure may be other shapes as long as the shape enables cutting of the electrode plate (10) moving in the first direction.

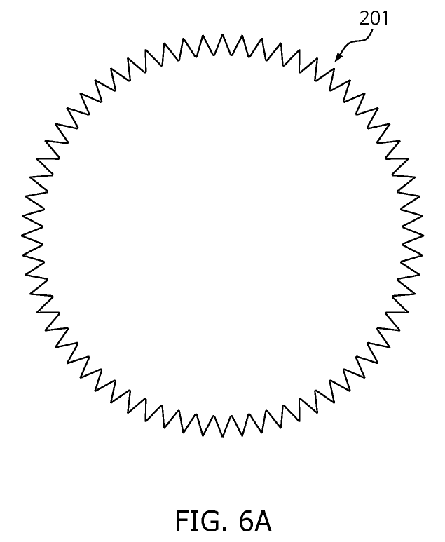

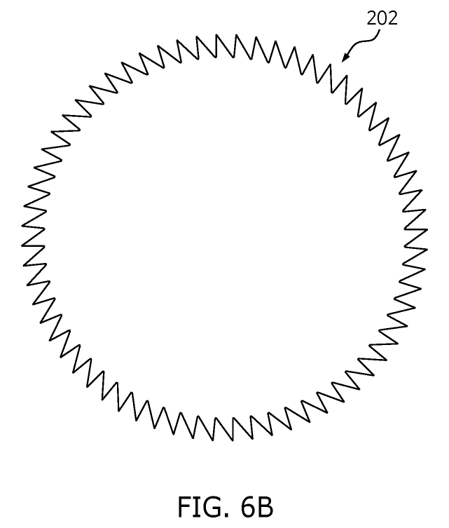

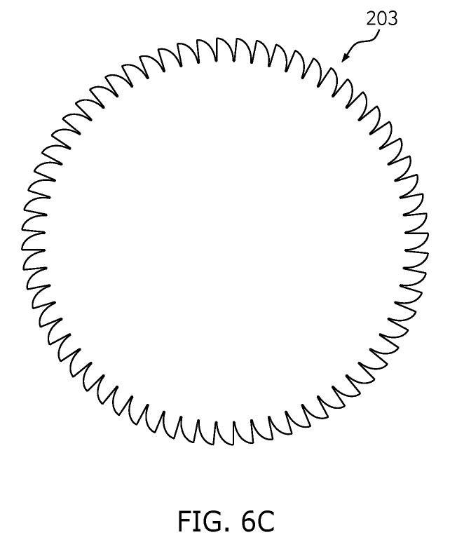

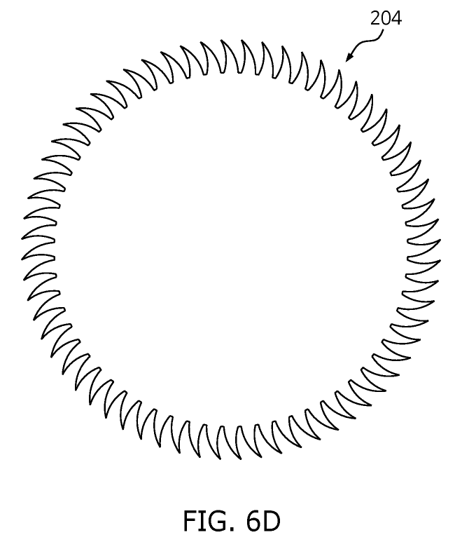

FIGS. 6a to 6d are views of a cross-sectional shape of a pattern cutter included in an apparatus for notching according to one or more example embodiments.

A cross-section of the pattern cutter (200) may be a circular saw shape, and the pattern cutter (200) may include a plurality of saw teeth that are a triangle shape or a shape in which at least one of two sides of a triangle is replaced with a curve.

Referring to FIGS. 6a and 6b, a cross-section of the sawtooth may be a triangle. Referring to FIG. 6c, the cross-section of the sawtooth may be a shape in which one side of a triangle is replaced with a curve. Moreover, referring to FIG. 6d, the cross-section of the sawtooth may be a shape in which two sides of a triangle are replaced with curves. In other embodiments, the cross-section shape of the pattern cutter (200) may be other polygon shapes, including shapes with an acute angle.

The cross-section shapes of the pattern cutter (200) depicted in FIGS. 6a to 6d are merely examples, and may be other shapes that are capable of cutting of the electrode plate (10). For example, the cross-section shape of the pattern cutter (200) may be an isosceles triangle or a right triangle. One angle of the isosceles triangle or the right triangle may be formed as needed. In some cases, the pattern cutter (200) may cut a specific region of the uncoated portion (14) and/or the mixture portion (12) while moving up and down relative to a side surface of the electrode plate (10).

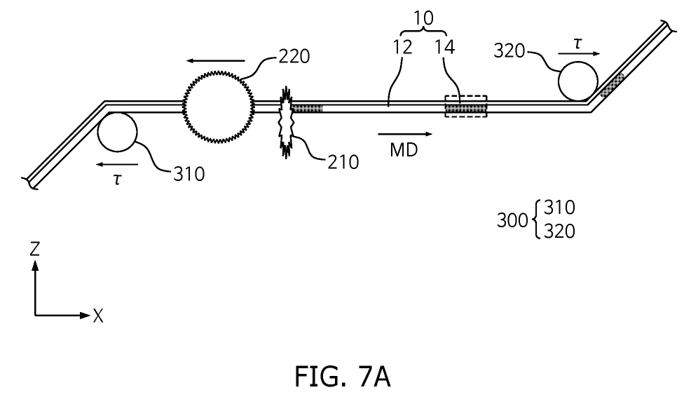

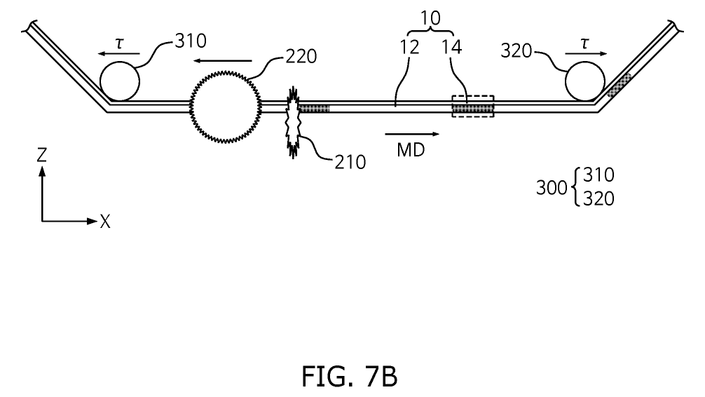

FIG. 7a is a view of an apparatus for notching that includes a plurality of rollers according to one or more embodiments. FIG. 7b is a view of an apparatus for notching that includes a plurality of rollers according to other embodiments.

Referring to FIGS. 7a and 7b, the apparatus for notching (1) according to one or more example embodiments may further include a plurality of rollers (300). The rollers (300) are in contact with the electrode plate (10) and move the electrode plate (10) along the first direction. The rollers (300) may thereby adjust tension in the electrode plate (10). The rollers (300) may include a first roller (310) and a second roller (320), and at least one of the pattern cutters (200) may be disposed between the first roller (310) and the second roller (320).

When forming the tab portion (16) using the pattern cutter (200), the first and second rollers (310, 320) disposed at ends of the pattern cutter (200) along the first direction may cause tension in opposite directions. Thus, the electrode plate (10) may be more uniformly drawn in the first direction. When performing an electrode plate manufacturing process using the plurality of rollers (300), it is possible to reduce nonuniform deformation formed on the electrode plate (10) and thereby prevent the electrode plate (10) from being thrust when it is cut by the pattern cutter (200). The movement direction (MD) of the electrode plate (10) may be changed due to the plurality of rollers (300). For example, while the speed of the electrode plate (10) may be constant, there may occur a speed component in the thickness direction. However, by providing the roller (300), it is possible to make the electrode plate (10) move only in the first direction. In another example, in a case where there is no pattern cutter (200) between two neighboring rollers (300), the electrode plate (10) may move in a direction that is not the first direction. However, the present disclosure is not limited thereto, and it is also possible to cause the electrode plate (10) to move in the parallel direction between the two neighboring rollers (300) even when necessary.

A change in the direction of the electrode plate (10) by the roller (300) may be a direction such that a height of the electrode plate (10) raised or may be a direction where the height at which the electrode plate (10) is lowered. When the electrode plate moves in a direction not parallel to the first direction by the roller (300), the electrode plate may be arranged in the first direction by a roller (300) that comes after the change in direction. A movement path of the electrode plate (10) may be selected using various combinations of the rollers (300).

According to one or more embodiments, the first roller (310) may be disposed on an upper surface or a lower surface of the electrode plate (10), and the second roller (320) may be disposed on the other one of the upper surface or the lower surface of the electrode plate (10). According to another embodiment, the first roller (310) may be disposed on any one of the upper surface or the lower surface of the electrode plate (10), and the second roller (320) may be disposed on a surface where the first roller (310) is disposed among the upper surface or the lower surface of the electrode plate (10).

Instead of the pattern cutter (200), or along with the pattern cutter (200), the wire cutter (100) may be disposed between the first and second rollers (310, 320). With such an arrangement, when the electrode plate (10) is cut by the wire cutter (100), it is possible to reduce deformation in the electrode plate (10) and prevent a thrust of the electrode plate (10) when the electrode plate (10) is cut by the wire cutter (100).

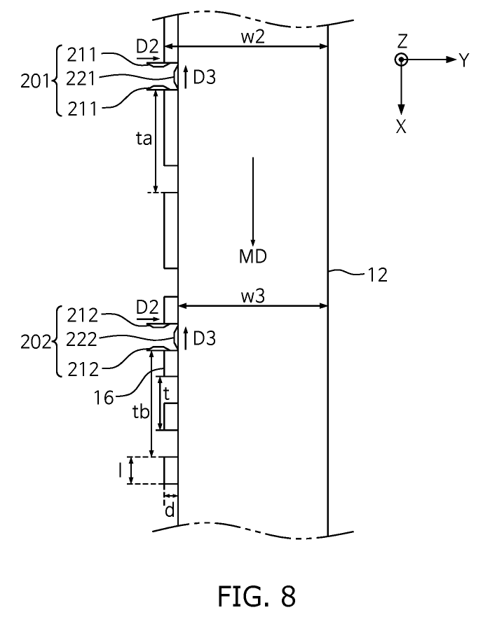

FIG. 8 is a plan view of notching an electrode plate using an apparatus for notching that includes a plurality of pattern cutters according to one or more example embodiments.

Referring to FIG. 8, in an apparatus for notching (2) according to one or more example embodiments, a plurality of pattern cutters (200) may include a first pattern cutter (201) and a second pattern cutter (202). A first pattern cutting element (211) and a second pattern cutting element (221) included in the first pattern cutter (201) may cyclically cut the electrode plate (10) at intervals (ta). The first pattern cutter (201) may form a first cut pattern on the electrode plate (10). The third pattern cutting element (212) and a fourth pattern cutting element (222) included in the second pattern cutter (202) may cyclically cut the electrode plate (10) at intervals (tb). The second pattern cutter (202) may form a second cut pattern on the electrode plate (10) by cutting the first cut pattern formed by the first pattern cutter (201). The formed second cut pattern may correspond to the tab portion (16).

The interval (ta) by the first pattern cutter (201) and the interval (tb) by the second pattern cutter (202) may be the same as each other or may be different from each other. For example, the intervals (ta, tb) by the first pattern cutter (201) and the second pattern cutter (202) may be the same as each other. When a center of the first cut pattern formed by the first pattern cutter (201) is cut by the second pattern cutter (202), an interval of the tab portion (16) of the electrode plate (10) wound by the winding roll (WR) may be constant. The interval (t) between the tab portions (16) may be less than the interval (ta, tb) by the first pattern cutter (201) and the second pattern cutter (202).

A plurality of pattern cutters (200) may include three or more pattern cutters (200). In some cases, intervals of each of the pattern cutters (200) may be different from each other, and at least a part may be the same as each other. When the intervals by the pattern cutters (200) are the same as each other, a cutting position of a subsequent pattern cutter (200) may be adjusted to divide the cut pattern formed on the pattern cutter (200) by N parts, and tab portions (16) at uniform interval (t) may be formed.

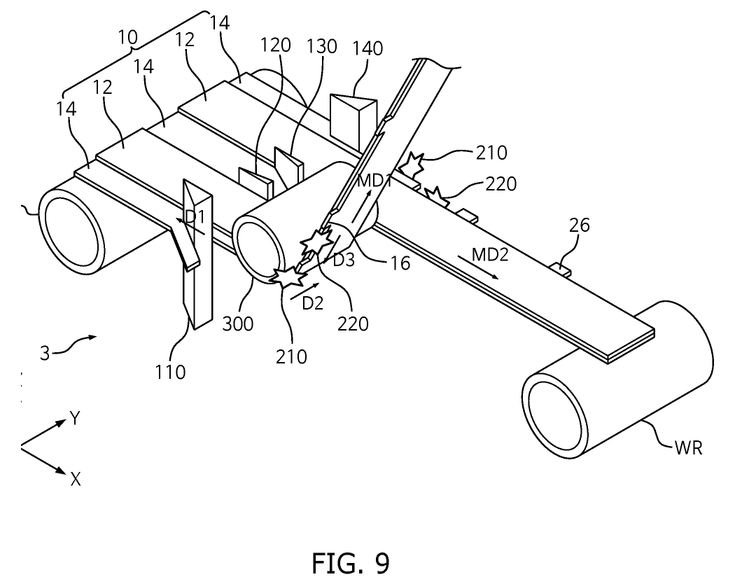

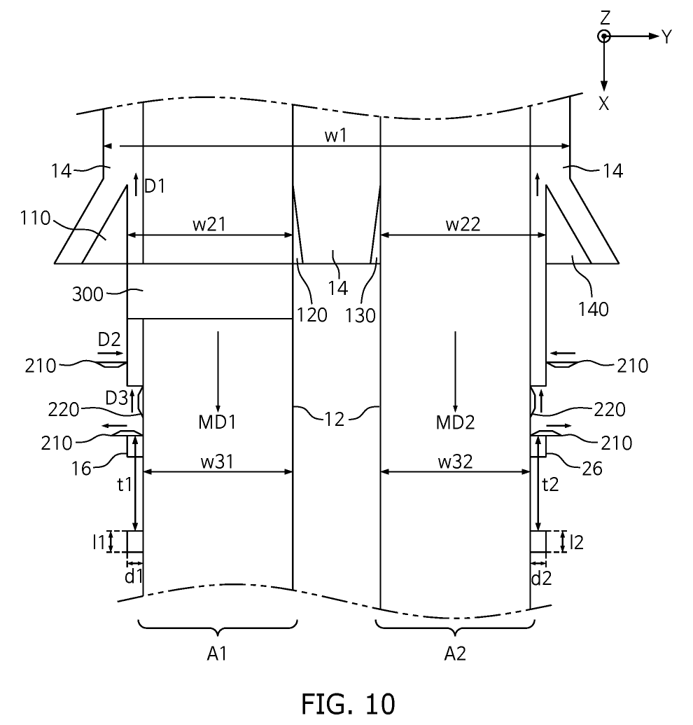

FIG. 9 is a perspective view of an apparatus for notching according to another example embodiment. FIG. 10 is a plan view of notching an electrode plate by an apparatus for notching according to one or more example embodiments.

Referring to FIGS. 9 and 10, in an apparatus for notching (3) according to one or more example embodiments, a width (w1) of the electrode plate (10) supplied by the supply roll (SR) may be two or more times larger than widths (w31, w32) of the electrode plate (10) wound by the winding roll (WR). In such an example, the electrode plate (10) may be notched after a plurality of electrode plates (10) are cut from the electrode plate (10) supplied by the supply roll (SR). For example, the electrode plate (10) before being cut may include two mixture portions (12) that are spaced from each other, and the uncoated portion (14) may be disposed on a first side surface and a second side surface positioned opposite to the first side surface of the electrode plate (10). That is, the uncoated portion (14) may be disposed between the two mixture portions (12). The first wire cutter (110) may be disposed on the first side surface to cut the uncoated portion (14), and the second wire cutter (120) and the third wire cutter (130) may be disposed between the two uncoated portions (12) to cut the uncoated portion (14), and the fourth wire cutter (140) may be disposed on the second side surface to cut the uncoated portion (14). The uncoated portion (12) may be exposed by being cut by the second wire cutter (120) and the third wire cutter (130). After passing through the wire cutter (100), the roller (300) may be disposed on an upper portion or a lower portion of a first region (A1) of the electrode plate such that the first region (A1) of the electrode plate (10) is moved by the roller (300). A second region (A2) of the electrode plate is not in contact with a separate roller (300). Thus, the first region (A1) and the second region (A2) may be separated from each other. Therefore, the movement direction (MD1) of the first region (A1) may be different from the movement direction (MD2) of the second region (A2). However, the present disclosure is not limited to such an arrangement, and in a case where the roller (300) is not provided, the two movement directions (MD1, MD2) may be substantially the same as each other.

An distance (w21) between the first wire cutter (110) and the second wire cutter (120) may be adjusted, and a distance (w22) between the third wire cutter (130) and the fourth wire cutter (140) may separately adjusted. Therefore, a width (w31) of the electrode plate (10) formed on the first region (A1) may be the same as a width (w32) of the electrode plate (10) formed on the second region (A2), or the widths (w31 and w32) may be different from each other.

The tab portions (16) of the first region (A1) and the tab portions (26) of the second region (A2) may be formed to have the same shape and intervals or may be formed to have different shapes or/and different intervals. For example, an interval (t1) between the tab portions (16) of the first region (A1) may be adjusted by the pattern cutter (200) such that intervals (t2) between the tab portions (26) of the second region (A2) are the same as each other, or may be adjusted by the pattern cutter (200) such that intervals (t2) between the tab portions (26) of the second region (A2) are different from each other. In another example, the depth (d1) and/or the length (l1) of the tab portion (16) of the first region (A1) may be adjusted by the pattern cutter (200) to be the same as the depth (d2) and/or the length (l2) of the tap portion (26) of the second region (A2) or different from thereof. In the example embodiment, cut patterns, that is, the tab portions (16, 26) may be formed on a cross-section cut by the first wire cutter (110) and a side surface cut by the fourth wire cutter (140). However, the present disclosure is not limited thereto. In another example a tab portion may be made to be formed on a side surface cut by the second or third wire cutter (120, 130) as well.

When the mixture portions (12) of the electrode plate (10) are not spaced apart from each other, the uncoated portion (14) may not be disposed between the mixture portions (12). In such an arrangement, the wire cutter (110) that cuts the mixture portion (12) in the first direction may be used, and the cut cross-section may correspond to a cross-section positioned opposite to a cross-section in which each tab portion (16, 26) is made.

The apparatus for notching (3) according to one or more example embodiments may be used in a slitting process for the electrode plate (10). That is, the apparatus for notching (3) can manufacture an electrode plate for a larger number of cells by cutting the electrode plate (10) into several rows. Therefore, the speed of the electrode plate manufacturing process may become faster. Moreover, in response to the electrode plate (10) having various sizes, different widths (w31, w32) of the electrode plate (10), and different lengths (11, 12), depths (d1, d2), and/or intervals (t1, t2) of the tab portions (16, 26) may be formed in a plurality of regions of the electrode plate (10). Through this, it is possible to provide an apparatus for notching having that is not limited to a specific die size and is not prone to errors caused by the abrasion to a die.

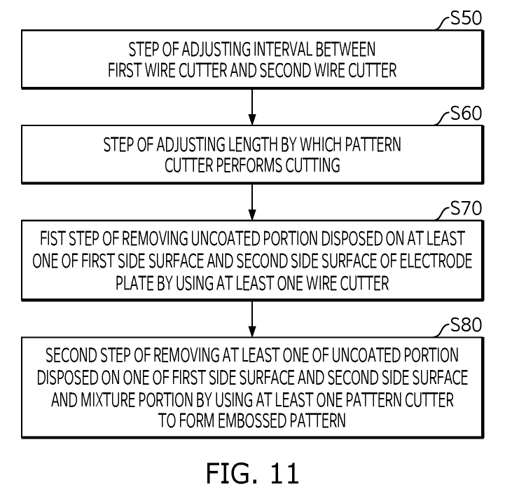

FIG. 11 is a flow chart of a method of notching according to one or more example embodiments.

Referring to FIG. 11, the method of notching according to one or more example embodiments may include a first step (S100) of removing the uncoated portion (14) disposed on at least one of the first side surface of the electrode plate (10) and the second side surface positioned opposite to the first side surface by using at least one wire cutter (100), and a second step (S200) of removing the uncoated portion (14) disposed on at least one of the first side surface and the second side surface and/or the mixture portion (12) in contact with one side end of the uncoated portion (14) by using at least one pattern cutter (200) to form a cut pattern. In the first step, the at least one wire cutter (100) may cut at least one of the first side surface and the second side surface of the electrode plate along the first direction in which the electrode plate moves, and the wire cutter (100) may be disposed to face the electrode plate along the first direction in which the electrode plate moves.

In the first step (S100), only a part of the uncoated portion (14) may be removed on the first side surface, and the entirety of the uncoated portion (14) may be removed on the second side surface. Moreover, on the second side surface, a part of the mixture portion (12) may be removed along with the uncoated portion (14). The uncoated portion that has not been removed in the first step (S100) may be further partially removed in the second step (S200), and the unremoved uncoated portion (14) may form the tab portion (16).

As the electrode plate (10) may be cut while moving in the first direction, a cutting direction (D1) in which the wire cutter (100) cuts the uncoated portion (14) may be the first direction. The cutting direction (D1) may be a direction and at a relative speed of the wire cutter (100) based on the electrode plate (10).

In the method of notching according to one or more example embodiments, the wire cutter (100) may be fixed in the first direction. That is, a speed at which the wire cutter (100) moves based on the first direction may be substantially close to 0. At this time, the electrode plate (10) may move along the first direction at a predetermined speed and contact the cutting edge of the wire cutter (100) . However, the present disclosure is not limited to such an arrangement, and the wire cutter (100) may move in the first direction.

In the method of notching according to one or more example embodiments, the cutting edge of the wire cutter (100) may extend in the thickness direction of the electrode plate.

In the method of notching according to one or more example embodiments, the wire cutter (100) may include the first wire cutter (110) and the second wire cutter (120) that are spaced from each other, and the distance between the first wire cutter (110) and the second wire cutter (120) may be adjustable. The first wire cutter (110) may cut the first side surface and the second wire cutter (120) may cut the second side surface. The method of notching according to one or more example embodiments may further include a step (S50) of adjusting a distance between the first wire cutter (110) and the second wire cutter (120) depending on a width of the supplied electrode plate (10) before the first step (S100). Here, the width of the supplied electrode plate (10) means a width of the electrode plate (10) intersecting the first direction, that is, a width (w1) of the electrode plate (10) perpendicular to the first direction. For example, in a case where the first direction is an X axis direction, the width of the supplied electrode plate (10) is along the second, Y axis, direction.

The first step (S100) of the method of notching according to one or more example embodiments may further include a step of adjusting a distance between the first wire cutter (110) and the second wire cutter (120) corresponding to the width (w1) of the supplied electrode plate (10). For example, the width (w2) may be adjusted to have a width having a certain difference from the width (w1) of the supplied electrode plate (10). According to other examples, the distance may be adjusted such that cutting is performed to make the width of the uncoated portion (14) disposed on the first side surface of the supplied electrode plate (10) uniform.

In the method of notching according to one or more example embodiments, the pattern cutter (200) may include the first pattern cutting element (210) and the second pattern cutting element (220).

In the second step (S200) in which the pattern cutter (200) forms a cut pattern, the pattern cutter (200) may move in the first direction at substantially the same speed as the electrode plate (10) moves in the first direction. As a relative speed of the pattern cutter (200) and the electrode plate (10) in the first direction is substantially close to 0, in the inertial system of moving at the speed, the pattern cutter (200) cuts the fixed electrode plate (10). After forming a cut pattern, the pattern cutter (200) may return to its original position. A step of the pattern cutter (200) returning to its original position may be included after the second step (S200).

The first pattern cutting element (210) may cut the electrode plate in the second direction, and the second pattern cutting element (220) may cut the electrode plate in the first direction or the third direction, which is different from the second direction. The first direction may correspond to a direction in which the electrode plate moves. For example, the second direction may intersect the thickness direction of the electrode plate (10) or a direction perpendicular to the thickness direction of the electrode plate (10). In the latter case, the first direction, the second direction, and the thickness direction of the electrode plate (10) may correspond to an X axis direction, a Y axis direction, and a Z axis direction, respectively. For example, the third direction may intersect the first direction and the second direction, respectively, or may be a direction perpendicular to the first direction and the second direction. That is, the first direction, the second direction, and the third direction may correspond to the X axis direction, the Y axis direction, and the Z axis direction, respectively. And the third direction may intersect the first direction and the second direction, respectively, or a direction perpendicular to the first direction and the second direction. The third direction may correspond to the thickness direction of the electrode plate (10). The electrode plate (10) may be cut in a direction perpendicular to the first direction and the thickness direction of the electrode plate (10). Moreover, the second pattern cutting element (220) may cut the electrode plate (10) in the thickness direction of the electrode plate (10) and may cut the electrode plate (10) in the first direction for adjustment of the interval of the tab portions (16).

The method of notching according to one or more example embodiments may further include a step (S60) of adjusting a length by which the pattern cutter (200) performs cutting such that the shape of the cut pattern is adjusted before the first step (S100). Through the length adjusting step (S60), a length (l), a depth (d), and an interval (t) of the tab portions (16) may be adjusted.

The spaced distance adjusting step (S50) and the cutting length adjusting step (S60) may be performed simultaneously or may be performed regardless of the order.

In the method of notching according to one or more example embodiments, a groove portion (18) may be formed by the pattern cutter (200). The groove portion (18) may be formed at substantially the same interval as the interval (t) of the tab portions (16).

As a spaced distance between the first wire cutter (110) and the second wire cutter (120) may be adjusted, the width of the electrode plate (10) may be adjusted depending on the size of the electrode plate (10) or the cell including the electrode plate (10) without the need for a separate die. Moreover, as the length cut by the first pattern cutting element (210) and the second pattern cutting element (220) may be adjusted, it is possible to adjust the width of the electrode plate (10), the interval (t) between the tab portions (16), the depth (d) and the length (l) of the tab portion (16), and/or the shape of the tab portion (16) depending on the size of the electrode plate (10) or the cell including the electrode plate (10) without using a separate die. That is, the method of notching according to one or more example embodiments may provide a method of notching can resolve problems in management of a die and other problems such as abrasion to the die.

Although the present disclosure has been described above with respect to embodiments thereof, the present disclosure is not limited thereto. Various modifications and variations can be made thereto by those skilled in the art within the spirit of the present disclosure.

### Explanation of reference symbols

1: Apparatus for notching 10: Electrode plate

12: Mixture portion 14: Uncoated portion

16: Tab portion 18: Groove portion

100: Wire cutter 110: First wire cutter

120: Second wire cutter 200: Pattern cutter

210: First pattern cutting element 220: Second pattern cutting element

What is claimed is:

1. An apparatus for notching, the apparatus comprising:
at least one wire cutter that is configured to cut at least one of a first side surface of an electrode plate and a second side surface of the electrode plate that is opposite to the first side surface, with the cutting being along a direction in which the electrode plate moves in the apparatus; and
at least one pattern cutter that is configured to cut at least one of the first side surface and the second side surface to form a cut pattern in the electrode plate,
wherein the wire cutter is positioned to face the electrode plate along the direction in which the electrode plate moves.

2. The apparatus for notching according to claim 1, wherein a cutting edge of the wire cutter is positioned to extend in a thickness direction of the electrode plate.

3. The apparatus for notching according to claim 1, wherein the wire cutter comprises a first wire cutter that is configured to cut the first side surface and a second wire cutter that is spaced from the first wire cutter and configured to cut the second side surface, and
wherein the distance between the first wire cutter and the second wire cutter is adjustable.

4. The apparatus for notching according to claim 1,
wherein the wire cutter is configured to cuts at least a part of an uncoated portion of the electrode plate from at least one of the first side surface and the second side surface, and
wherein the pattern cutter is configured to cut at least one of the uncoated portion of the electrode plate disposed on at least one of the first side surface and the second side surface and a mixture portion that is between the uncoated portion.

5. The apparatus for notching according to claim 1, wherein the wire cutter is disposed to be fixed while the electrode is moving.

6. The apparatus for notching according to claim 1, wherein each of the wire cutter and the pattern cutter comprises at least one of metal, carbon steel, stainless steel, ceramic, and diamond.

7. The apparatus for notching according to claim 1, wherein the pattern cutter is configured to move at a same speed as the electrode plate in the direction that the electrode plate moves.

8. The apparatus for notching according to claim 1, wherein the direction that the electrode moves is a first direction, and
wherein the pattern cutter comprises a first pattern cutting element that is configured to cut the electrode plate in a second direction and a second pattern cutting element that is configured to cut the electrode plate in the first direction or a third direction.

9. The apparatus for notching according to claim 8, wherein the first pattern cutting element is configured to face a side surface of the electrode plate along the second direction, and with the second direction intersecting a thickness direction of the electrode plate.

10. The apparatus for notching according to claim 1, wherein a cross-sectional shape of the wire cutter is (i) triangular, (ii) a shape in which one side of a triangle is replaced with a curve, or (iii) a polygon shape with an acute angle,
wherein one side of the wire cutter is parallel to the first direction, and
wherein the pattern cutter comprises a plurality of saw teeth that are triangular shape or a shape in which at least one of side of a triangle is replaced with a curve.

11. The apparatus for notching according to claim 1, wherein a cross-section shape of the pattern cutter is an isosceles triangle or a right triangle.

12. The apparatus for notching according to claim 1, wherein the pattern cutter comprises a first pattern cutter and a second pattern cutter, and
wherein the second pattern cutter is configured to form a second cut pattern by cutting a first cut pattern that is cut by the first pattern cutter.

13. An apparatus for notching, the apparatus comprising:
at least one wire cutter that is configured to cut a first side surface of an electrode plate and a second side surface of the electrode plate that is opposite to the first side surface of the electrode plate, with the cutting being along a first direction in which the electrode plate moves in the apparatus; and
at least one pattern cutter that is configured to cut at least one of the first side surface and the second side surface to form a cut pattern,
wherein the wire cutter is positioned to face the electrode plate along the first direction,
wherein a cutting edge of the wire cutter is configured to extend in a thickness direction of the electrode plate,
wherein the wire cutter comprises a first wire cutter that is configured to cut the first side surface and a second wire cutter that is spaced a distance from the first wire cutter and is configured to cut the second side surface,
wherein the distance between the first wire cutter and the second wire cutter is adjustable, and
wherein the pattern cutter comprises a first pattern cutting element that cuts the electrode plate along a second direction and a second pattern cutting element that cuts the electrode plate along the first direction or a third direction that is different from the second direction.

14. A method for notching comprising:
a first step of cutting an uncoated portion disposed on at least one of a first side surface of an electrode plate and a second side surface of the electrode plate that is positioned opposite to the first side surface, the cutting being along a direction that the electrode plate is moving, the cutting being performed by at least one wire cutter; and
a second step of removing at least one of the uncoated portion disposed on one of the first side surface and the second side surface and a mixture portion, the removing being performed by using at least one pattern cutter to thereby form a cut pattern.

15. The method for notching according to claim 14, wherein the wire cutter is fixed to face the electrode plate along the first direction.

16. The method for notching according to claim 14, wherein a cutting edge of the wire cutter extends in a thickness direction of the electrode plate,
wherein the wire cutter comprises a first wire cutter that cuts the first side surface and a second wire cutter that is spaced a distance from the first wire cutter and cuts the second side surface, and
wherein the distance between the first wire cutter and the second wire cutter is adjustable.

17. The method for notching according to claim 16, the method further comprising, before the first step, a step of adjusting the distance between the first wire cutter and the second wire cutter based on a width of the electrode plate that intersects the first direction.

18. The method for notching according to claim 16, wherein the first step further comprises a step of adjusting a distance between the first wire cutter and the second wire cutter based on a width of the electrode plate that intersects the first direction.

19. The method for notching according to claim 14, wherein the pattern cutter comprises a first pattern cutting element that cuts the electrode plate along the second direction and a second pattern cutting element that cuts the electrode plate along the first direction or a third direction that is different from the second direction.

20. The method for notching according to claim 14, the method further comprising, before the first step, a step of adjusting a length by which the pattern cutter performs the cutting such that at least one of a shape or an interval of the cut pattern is adjusted.
